(19) United States
(12) Patent Application Publication
(10) Pub. No.: US 2007/0154567 A1
(43) Pub. Date: Jul. 5, 2007

(54) Use of mercury to treat cancer

(76) Inventor: Yelena G. Sheptovitsky, Stamford, CT (US)

Correspondence Address: Yelena G. Sheptovitsky, 62 Mill Brook Road, Stamford, CT, 06902, US

(21) Appl. No.: 11/324,850

(22) Filed: Jan. 4, 2006

(51) Int. Cl. A01N 59/18

(52) U.S. Cl. 424/644; 424/645

(57) ABSTRACT

The invention relates to the use of inorganic mercury (II) in an ionized or ionizable state to treat a variety of solid tumors and lymphoma and leukemia. The present invention also relates to pharmaceutical compositions useful for treating cancer, such as solid tumor and lymphoma, which comprises inorganic mercury (II). The present invention further relates to methods for treating cancer, such as solid tumor or lymphoma or leukemia using inorganic mercury (II).

### BACKGROUND OF THE INVENTION

The present invention relates to inorganic mercury (II) compounds. The present invention relates to therapeutic use of inorganic mercury (II) compounds as anti-cancer drugs. The present invention also relates to pharmaceutical compositions useful for treating cancers. The present invention further relates to methods for treating cancer with inorganic mercury (II) compounds.

Cancer is characterized primarily by an increase in the number of abnormal cells derived from a given normal tissue, invasion of adjacent tissues by these abnormal cells, and lymphatic or blood-borne spread of malignant cells to regional lymph nodes and to distant sites (metastasis). Studies indicate that cancer is a multistep process that begins with minor preneoplastic changes, which may under certain conditions progress to neoplasia. Currently surgery, radiation and chemotherapy remain the major and most effective modalities used for cancer treatment. Among chemotherapy drugs are alkylating agents, antimetabolites and antibiotics that target tumor cells and normal cells alike causing severe side effects. Also there have been significant advances in the development of novel cancer treatments such as immunotherapy, photodynamic, laser and gene therapies, hyperthermia, inhibition of angiogenesis, etc. The search for new cancer therapies continues, as there is a great need for effective treatments of cancer. The present invention addresses this need in the art.

For centuries, mercury was an essential part of many different medicines. Mercury-containing drugs included diuretics, antibacterial agents, antiseptics, and laxatives. In spite of a long history of mercury use in medicine, due to growing concerns about mercury toxicity in environmental and occupational exposure (Kazantzis, 2002, Med Lav 93:139-47), its use in conventional medicine is currently very limited (Mercury in Drug and Biologic Products. FDA document, Aug. 5, 2003).

Mercury toxicity has been studied extensively in medicine (Langford N. et al., 1999, J Hum Hypertens. 13(10):651-6, Toxicological profile for mercury. U.S. Department of health and human services, Public Health service, Agency for Toxic Substances and Disease Registry). Mercury is a highly toxic non-essential heavy metal that has three different species with distinct pharmacokinetics and toxicity profiles: elemental mercury metal, inorganic mercury salts and organometallic mercury compounds. Inorganic mercury salts are a far greater hazard than metallic mercury. The majority of ingested inorganic mercury salt accumulates either in the liver where it is excreted in the bile, or in the kidney, where it's excreted in the urine. The symptoms and signs of inorganic mercury poisoning are mercurial stomatitis, loosening of the teeth and renal damage. Inorganic mercury salts do not cross the blood brain barrier in significant amounts as opposed to organic mercury compounds where toxicity is mostly seen in the central nervous system.

There is a vast amount of literature about toxicity of inorganic mercury in vivo and in vitro. Mercury (II) salts were reported to induce apoptosis (Duncan-Achanzar et al., 1996, J. Pharmacol. Exp. Ther. 277: 1726-1732), interfering with essential metals (Weinsberg et al., 1995, Arch. Toxicol. 69: 191-6) affecting their role as cofactors for enzymes, metabolic and transcription processes, form conjugates with proteins through their thiol groups (Sundberg et al., 1999, Toxicology 137: 169-84), cause autoimmunity at subtoxic concentrations (Pollard et al., 1997, Met. Ions Biol. Syst. 34:421-40), be mutagenic, clastogenic and teratogenic.

Surprisingly, mercury was found to be non-carcinogenic in vitro (Ariza et al., 1996, Environ. Mol. Mutagen; 27(1):30-3., Ariza et al., 1995, Environ. Mol. Mutagen; 25: 3) and it does not meet requirements to be classified as a human carcinogen (Toxicological profile of Mercury, March 1999, CAS# 7439-97-6, Agency for Toxic Substances and Disease Registry; U.California 2004 Reference List). In fact, mercury has been shown to be preferentially absorbed by cancer and precancer cell nuclei (Omura et al., 1996, Acupunct. Electrother Res; 21(2):133-60., Kanai et al., 1980, Shinshu Igaku Zasshi; 28(2):221-228), and there have been some disclosures regarding the use of mercury in treating cancer. Vorobieva, U.S. Pat. No. 5,889,048, discloses and claims the use of mercury dichloride formulated at 0.05-1.5% by weight in either dry white wine with a sugar content of 3-4% or whey with a sugar content of 3-4%, or pork fat plus natural honey and alcohol for the treatment of various cancers. The wine, whey or pork fat in these formulations was claimed as an essential ingredient that renders the claimed pharmaceutical levels of mercury non-toxic and helps deliver it to the target tissue by forming covalent complexes through the SH groups of denatured proteins. Bodaness et al., U.S. Pat. No. 5,563,132, discloses the use of mercury porphyrin as one of many other metal porphyrins for a two-step cancer treatment method. Initially metal porphyrins are administered to localize the tumor. Then hydrogen peroxide introduced in the second step of the treatment reacts with metal porphyrins to form oxygen radicals that subsequently destroy cancer cells. Metal porphyrin has a dual function in this treatment: first, it localizes the tumor, and second, it is one of two components of the reaction that produces species with tumor-killing properties. Administration of metal porphyrins alone does not achieve anti-tumor therapeutic effect.

Mercury compounds have been disclosed by a number of authors to be used as cytotoxic agents in surgery for irrigation purposes to remove any stray tumor cells remaining after removal of the tumor. Umpleby et al., 1984, Ann. Royal Coll. Surg. Engl. 66:192 discloses using 0.2% mercuric perchloride (w/v) during surgery on patients for colorectal cancer—applied either before or after resection of the bowel to prevent “suture line” recurrence of colorectal cancer after surgery. Van Delft et al., 1983, Documenta Ophthalmologica 56:61-67 discloses irrigating with a solution of 0.1% (w/v) mercuric chloride during conjunctival surgery (melanoma). A specific procedure is disclosed: the surgical site is irrigated with mercuric chloride solution prior to surgery; the tumor is excised and then washed with sodium hypochlorite. In another form of topical application, Gibson et al., 1970, Cancer 26:76-80 discloses that a solution of mercuric chloride (0.2% w/v) was found in mice to reduce mammary and sarcoma “tumor growth” in “seeded” wounds in mice when administered to the wound site.

However, none of these references contemplates or even suggests the systemic delivery of non-covalently bound inorganic mercury (II) in its ionized or ionizable form for the treatment of cancer. U.S. Pat. No. 5,889,048 discloses the systemic delivery of mercury (II) covalently bound to denatured proteins in wine or food, and claims formulations containing such ingredients. The latter formulations are obviously limited to administration by mouth. Accordingly, there is a great need for pharmaceutical formulations enabling systemic delivery of inorganic mercury (II) for the treatment of cancer.

### BRIEF SUMMARY OF THE INVENTION

The present invention provides a novel therapy for the treatment of cancer in mammals. It has been discovered that inorganic mercury (II) in its ionized or ionizable form has broad applicability in the treatment of a broad spectrum of cancers when introduced systemically. Mercury in its ionized form or a form that is ionizable upon reconstitution or administration (for example, by oral digestion) is not covalently bound to any other substances including but not limited to protein, fats and carbohydrates (e.g., sugars). Any route of administration that provides systemic delivery of inorganic mercury (II) is acceptable and it may include oral, parenteral, pulmonary, transdermal and local administration routes. Free or coordinated mercury ion (II) is an active species for this treatment. Accordingly, the invention encompasses inorganic mercury (II) compounds, the preparation of these compounds, their incorporation into pharmaceutical compositions and their use to treat cancer. The invention described herein encompasses any mercury (II) compounds containing mercury (II) in an ionized or ionizable state that can alleviate, reduce, ameliorate, or prevent cancer; or place or maintain in a state of remission of clinical symptoms or diagnostic markers associated with cancer.

The invention is directed to a method for inhibiting proliferation of cancer cells, treating cancer and/or inhibiting metastases in a mammal in need thereof comprising administering at least once to a said mammal a composition comprising inorganic mercury in ionized or ionizable form and a carrier or excipient in an amount effective to inhibit proliferation of said cancer cells, treat cancer and/or inhibit metastases. The composition may be administered systemically, topically, and/or transdermally. In a specific embodiment, it is administered systemically by oral, parenteral or pulmonary means at least once to said mammal. In another specific embodiment, the composition of the present invention is administered at least twice to said mammal. In a more specific embodiment, the composition of the present invention is administered topically, locally or transdermally at least twice to said mammal.

The present invention also encompasses compositions useful for treating cancer, which comprise inorganic mercury (II) preferably with a pharmaceutically acceptable carrier or excipient. In a preferred embodiment, the invention encompasses a composition suitable for oral delivery, comprising inorganic mercury (II) and a pharmaceutically acceptable carrier or excipient in liquid formulation, tablet, capsule, or other single unit dosage form. In another embodiment, the invention includes compositions suitable for parenteral, pulmonary, transdermal and local deliveries. Specific therapeutic regimens, pharmaceutical compositions, and kits are also provided by the invention. Specifically, the invention is directed to compositions comprising inorganic mercury (II) not covalently bound to any (macro) molecular structure and present preferably in an amount of about from 0.1 nanomole to 50 millimole Hg²⁺per dose and a carrier or excipient which may be in a single selling unit. In a specific embodiment, the composition is non-wine, non-whey, non-pork fat containing composition comprising an inorganic mercury (II) containing compound present in an amount of about from 0.1 nanomole to 50 millimole of Hg²⁺per single dosage unit and a carrier or excipient. The invention is also directed to an aqueous buffered composition, comprising inorganic mercury (II) in an injectable or oral form, as well as a method of production of the composition. The composition for oral, transdermal or local administration may also be in solid form.

In yet another specific embodiment, the invention is directed to a method for inhibiting metastases of a tumor in a mammal in need thereof comprising administering to said mammal in need thereof a non-wine, non-whey, non-pork fat containing composition comprising an amount of at least one inorganic mercury (II) compound in ionized or ionizable form effective to inhibit said metastases.

The invention is further directed to use of a non-wine, non-whey, non-pork fat containing composition comprising an amount of ionized or ionizable inorganic mercury (II) to formulate a medicament and/or pharmaceutical composition for use in treating cancer in a mammal.

A single treatment course of inorganic mercury (II) consists of its single administration or repeated daily or every other day administration for a certain period of time The method in a more specific embodiment comprises an initial treatment course of said composition and at least one subsequent treatment course of said composition at least 2 days after the initial treatment course. The method in yet a more specific embodiment, comprises an initial treatment course of said composition and at least two subsequent treatment courses of said composition at least 2 days after the initial treatment course.

### BRIEF DESCRIPTION OF THE SEVERAL VIEWS OF THE DRAWING

### Not Applicable

### DETAILED DESCRIPTION OF THE INVENTION

The present invention encompasses pharmaceutical compositions useful for treating cancer, which comprise inorganic mercury (II) preferably with a pharmaceutically acceptable carrier or excipient. In a preferred embodiment the invention encompasses a composition suitable for parenteral or oral delivery which comprises inorganic mercury (II), and preferably a pharmaceutically acceptable excipient or carrier in liquid or tablet, capsule, or other single unit dosage form.

This invention also encompasses a method for treating cancer in a mammal including a human, which comprises administering to a subject in need of such therapy a therapeutically effective amount of inorganic mercury (II), preferably with a pharmaceutically acceptable carrier or excipient. The cancers may be solid tumors or disperse cancers.

For clarity of disclosure, and not by way of limitation, the detailed description of the invention is divided into subsections which follow.

### The Inorganic Mercury (II)

As used herein, “inorganic mercury (II)” refers to, in a pharmaceutically acceptable form, a compound which comprises mercury (II) in an ionized or ionizable state. The invention encompasses all pharmacologically active species of inorganic mercury (II). The term “inorganic mercury (II)” encompasses any inorganic and organic compound that generates free or coordinated mercury (II) ion in a pharmaceutical formulation or upon administration. Any ionized or ionizable mercury (II) compound(s), when used alone or in combination with other compounds, that can alleviate, reduce, ameliorate, prevent, or place or maintain in a state of remission of clinical symptoms or diagnostic markers associated with cancers, can be used in the present invention.

Examples of “mercury (II) compound” include but not limited to mercury (II) salts and mercury (II) oxide.

### Compositions and Modes of Administration

For oral administration, the compositions of the present invention may be in liquid form, for example, solutions, syrups or suspensions, or may be presented in solid form for reconstitution with water or as tablets or capsules. For pulmonary administration, the compounds for use according to the present invention are conveniently delivered in the form of an aerosol spray. The compounds may be formulated for parenteral administration by injection, e.g., by bolus injection or continuous infusion. Formulations for injection may be presented in unit dosage form, e.g., in ampoules or in multi-dose containers, with an added preservative.

In a specific embodiment, the compounds may be formulated into an aqueous composition, particularly, pharmaceutical composition for intravenous injection. Mercury (II) compound is diluted in a buffered aqueous solution at concentrations desirably within the 1 nanoM-1 M range. Preferable formulation for oral and parenteral administration includes 2-200 mM, preferably 20 mM NaAcetate pH 4.5, 40-400 mM, preferably, 100 mM sucrose, 15-300 mM, preferably, 150 mM NaCl. The final solution may then be sterilized, for example by filtration through a 0.22 micron filter, and stored in sterile vials. Pharmaceutical compositions containing mercury (II) compounds that are manufactured by the method of the invention show stability and long shelf life. The solution when administered parenterally can then be administered either directly through the IV catheter using syringe, or administered by IV pump in diluted form continuously during the day.

### Treatment and Dosing Schedules.

A single treatment course of inorganic mercury (II) in the acute or chronic management of cancer might consist of either its single administration or repeated administration preferably for 1-365 days. Each treatment course might be repeated a number of times with generally 2-30 days of intervals in between. The duration of a single treatment course and the required number of such treatment courses will vary and be determined by a cancer type, stage of the disease, bulk amount of tumor masses present at initiation time and individual patient's response. The magnitude of a therapeutic dose of inorganic mercury (II) will also vary with the severity of the condition to be treated and the route of administration. Doses will be derived from known toxicity information that will include but not limited to bioavailability data, minimal risk levels (MRL), no-observed-adverse events levels (NOAEL), less serious and serious lowest-observed-adverse-events levels (LOAEL). The therapeutic doses for short-term and long-term treatments will generally be between MRL and serious LOAEL. The doses are calculated in the micromole Hg²⁺/kg/day units. Common conversion formulas will be used for calculations of daily doses for different species including a human, dog or cat (Cancer Chemotherapy Reports 50(4): 219 (1966)). The daily dose might be administered either in repeated increments during day or once a day or a doubled daily dose every other day. Generally, the daily dose for inorganic mercury (II) will range from about 0.001 to 100 micromole Hg²⁺/kg/day for humans and corresponding mg/m² dose equivalences for other species.

Here is an exemplary course of treatment of a human patient with leukemia, lymphoma, or solid cancer by oral administration of a composition comprising mercury (II) inorganic compound in an aqueous solution. Human MRL for intermediate oral exposure to mercuric chloride derived from 26 weeks study in rats is 0.002 mg/kg/day or approximately 0.007 micromole Hg²⁺/kg/day, NOAEL is 0.027 mg/kg/day or approximately 0.09 micromole Hg²⁺/kg/day, and the acute exposure LOAEL for serious effects in humans is known to be 30 mg/kg/day or approximately 100 micromole Hg²⁺/kg/day (Toxicological profile of Mercury, March 1999, CAS# 7439-97-6, Agency for Toxic Substances and Disease Registry). Since inorganic mercury is preferentially absorbed by cancer cells (Omura et al., 1996, Acupunct. Electrother Res; 21(2):133-60., Kanai et al., 1980, Shinshu Igaku Zasshi; 28(2):221-228), its toxicity effects in cancer patients will be observed at higher mercury levels than the levels expected for healthy individuals. Thus, the therapeutic dose range for 180-day treatment course of human cancer with oral administration will likely be between 0.1-10 micromoles Hg²⁺/kg/day. Higher doses might be used for a shorter than 180-day treatment period. Lower doses might be used for a longer than 180-day treatment period. The therapeutic dose is given preferably 1-3 times a day on an empty stomach 1 hr before or after taking food. The course of treatment may continue until remission is observed, or when side effects should become serious, or when it reaches 365 days. It is preferred that the duration of the first treatment course be 30-180 days depending on the severity of condition. If after 180 days of treatment, a patient does not respond favorably, the treatment may be stopped. The course of treatment may be repeated multiple times with about 2-30 day intervals between courses

The method of the present invention may be used to treat primary cancers as well as metastatic tumors. The primary cancer may be a solid tumor or disperse cancer. The solid tumor may include but is not limited to lung cancer, breast cancer, ovarian cancer, prostate cancer, bowel cancer, brain cancer, testicular cancer, colon cancer, liver cancer, kidney cancer, pancreas cancer, skin cancer, neck cancer, uterus cancer, bone cancer. The disperse cancer may be leukemia or lymphoma. Whenever possible, it is preferred that the bulk of tumor be removed surgically prior to treatment to optimize its outcome.

In a specific embodiment, the composition of the present invention is administered systemically to the mammal (e.g., human, dog, cat) at least once. In a more specific embodiment, the method comprises an initial administration of the composition of the present invention and at least one subsequent administration of said composition generally 2-30 days after initial administration. In yet another specific embodiment, the method further comprises subsequent administration of said composition at least two times after initial administration.

In a particular embodiment, more than one mercury (II) compound may be administered. The compounds may be administered sequentially or simultaneously. Again, any suitable route of administration may be employed for providing the patient with an effective systemic dosage of inorganic mercury (II) (See, Remington's Pharmaceutical Sciences, J. P. Remington, Easton, Pa.: Mack Pub. Co., 18^{th} Edition, 1990).

### EXAMPLES

In the examples described herein, the method of the present invention was tested for the treatment of cancer in pet dogs.

### Example 1

A 7 years old, 106 lbs male Labrador Retriever, was diagnosed with apocrine gland adenocarcinoma, metastatic to lymph node. The lump on the neck was surgically removed and biopsy analysis was performed.

### Clinical Evaluation Prior to Treatment

Pathology report

“Microscopic description. Sections of caudal cervical mass are examined. An unencapsulated mass nearly completely effaces a lymph node. It is composed of neoplastic epithelial cells that form nests, cords, and acini. The cells have hyperchromatic, ovoid to reniform nuclei with coarsely clumped and marginated chromatin. Nucleoli are prominent. There is a moderate mitotic rate. The cytoplasm is abundant, polyhedral with distinct cell margins. There is a marked scirrhous reaction in response to the neoplasm. In some areas of the tumor, the stroma comprises the bulk of the mass effect. There is focally extensive coagulation and hemorrhagic necrosis of the tumor associated with suppurative inflammation. Neoplastic cells extend to the surgical margins of the biopsy specimen.

Microscopic findings: Adenocarcinoma, metastatic to lymph node.

Comment: The adenocarcinoma has metastasized to a lymph node. This may be the superficial cervical lymph node. The primary site is unclear. There are no morphologic features that clearly identified the histogenic origin. Differentials considered are apocrine glands of the skin and salivary gland adenocarcinoma. The prognosis for metastatic adenocarcinoma is poor.”

Treatment

The owner chose not to pursue chemo- and radiation therapies. Instead, the dog undertook a full course of inorganic mercury (II) treatment. The treatment consisted of total of 150 days including three 30-day treatment courses and two 30-day interval periods between courses. The formulation contained 1 mM mercury acetate in 20 mM sodium acetate buffer, pH 4.5, with 100 mM sucrose and 150 mM sodium chloride additives. The formulation was introduced orally to the pet three times a day 1 hour before taking food at 0.5 micromole Hg²⁺/kg/day.

Owner's notes.

Day 56: “. . . D. seems to be doing very well. After about 4 days of the (inorganic mercury, Y.S.) treatment, his energy increased and he seemed like his old self again. He has been doing very well ever since”.

Day 121: “. . . D. continues to show no negative signs, his appetite is great, and his attitude is as cheerful and playful as ever . . . ”

Day 356: “. . . D. had a chest x-ray yesterday (Apr. 28, 2004—Day 356) and I am happy to report that Dr. H. (veterinarian, Y.S.) saw no metastases.”

Post treatment evaluation by an oncologist and a veterinarian showed no evidence of metastasis or new mass growth detected in abdominal, lymph nodes or chest, as it was confirmed by X-rays and ultrasound examination. The blood data at Day 175 were normal (see Table 1).

TABLE 1
Blood data for Labrador retriever dog at Day 175 of inorganic
mercury (II) treatment.

| Blood Parameter | Day 175 |
|---|---|
| Glucose, mg/dL | 105 |
| Urea Nitrogen, mg/dL | 20 |
| Creatinine, mg/dL | 1.2 |
| Total Protein, g/dL | 7.3 |
| Albumin, g/dL | 3.9 |
| Total Billirubin, mg/dL | 0.2 |
| Alkaline Phosphatase (ALP), U/L | 94 |
| ALT (SGPT), U/L | 52 |
| AST (SGOT), U/L | 29 |
| Cholesterol, mg/dL | 322 |
| Calcium, mg/dL | 10.3 |
| Phosphorus, mg/dL | 4.6 |
| Sodium, mE/L | 151 |
| Potassium, mE/L | 5.1 |
| Chloride, mE/L | 115 |
| Albumin/Globulin Ratio | 1.1 |
| BUN/Creatinine Ratio | 17 |
| Globulin, g/dL | 3.4 |
| CPK, U/L | 267 |
| Hemoglobin, g/dL | 17.7 |
| Hematocrit, % | 53.7 |
| WBC, 10³/microl | 8.9 |
| RBC, 10⁶/microl | 8.1 |
| MCV | 66 |
| MCH | 21.9 |
| MCHC | 33.0 |
| Platelet count, 10³/microl | 294 |
| Neutrophils, absolute, (%) | 5340 (60) |
| Bands | 0 |
| Lymphocytes, absolute, (%) | 2759 (31) |
| Monocytes, absolute, (%) | 356 (4) |
| Eosinophils, absolute, (%) | 445 (5) |
| Basophils, absolute, (%) | 0 |

The dog continues to be healthy 13 months after completing the treatment (to present day).

### Example 2

A 10 yrs old female Husky, 54 lbs was diagnosed with metastatic hepatocellular carcinoma. The tumor was surgically removed prior to treatment. The prognosis after the surgery was poor with 1-2 months of life expectancy.

### Clinical Evaluation Prior to Treatment

Pathology Report

“Diagnosis: Consistent with (metastatic) hepatocellular carcinoma Microscopic: 03B-926 Specimen (liver/lung mass) is hepatoid type mass characterized by central obliterating sheets of large bizarre hepatocytes consistent with invasive hepatocellular carcinoma. High mitosis with invasive and metastatic potential. Prognosis: poor.”

The 90-day inorganic mercury (II) treatment consisted of two 30-day treatment courses and one 30-day interval period. The formulation contained 1 mM mercury acetate in 20 mM sodium acetate buffer, pH 4.5, with 100 mM sucrose and 150 mM sodium chloride additives. The formulation was introduced orally to the pet three times a day 1 hour before food at 0.5 micromole Hg²⁺/kg/day. In the beginning of treatment the dog had high levels of alkaline phosphatase (ALP) and alanine transferase (ALT), two liver enzymes known to be associated with liver tumor progression (de Oliveira e Silva et al., Arq Gastroenterol. 1990, 27(2):83-94). The levels of these enzymes, were dramatically decreased during the first treatment course (see Table 2). On Day 3 ALP and ALT were 1950 U/L and 119 U/L, respectively. On day 30 ALP dropped to 495 U/L, whereas ALT was decreased to 27 U/L. Decreases in ALP and ALT levels were correlated well with the improvement of dog's general condition during the first treatment course. During the second treatment course, according to owner's and veterinarian's notes, the dog continued to show improvement and at the end of the treatment period it acted as a healthy dog. Unfortunately, the owner chose not to take blood tests after day 30. The dog remains in good health and is apparently cancer-free 10 months after treatment (to present day).

TABLE 2
Blood data for 10 yrs old female Husky at Day 3, 9 and 30 of inorganic
mercury (II) treatment.

| Blood Parameter | Day 3 | Day 9 | Day 30 |
|---|---|---|---|
| Glucose, mg/dL | 94 | 93 | 113 |
| Urea Nitrogen, mg/dL | 17 | 8 | 14 |
| Creatinine, mg/dL | 1.0 | 1.0 | 0.9 |
| Total Protein, g/dL | 5.9 | 6.2 | 6.4 |
| Albumin, g/dL | 3.1 | 3.2 | 3.4 |
| Total Billirubin, mg/dL | 0.1 | 0.1 | 0.1 |
| Alkaline Phosphatase (ALP), U/L | 1950 (H) | 1368 (H) | 495 (H) |
| ALT (SGPT), U/L | 119 (H) | 51 | 27 |
| AST (SGOT), U/L | 30 | 18 | 26 |
| Cholesterol, mg/dL | 250 | 237 | 248 |
| Calcium, mg/dL | 9.4 | 9.8 | 10.3 |
| Phosphorus, mg/dL | 3.8 | 3.8 | 3.3 |
| Sodium, mE/L | 149 | 152 | 152 |
| Potassium, mE/L | 4.5 | 4.7 | 4.1 |
| Chloride, mE/L | 114 | 115 | 117 |
| Albumin/Globulin Ratio | 1.1 | 1.1 | 1.1 |
| BUN/Creatinine Ratio | 17 | 8 | 16 |
| Globulin, g/dL | 2.8 | 3.0 | 3.0 |
| CPK, U/L | 161 | 119 | 488 |
| Corrected Calcium | 9.8 | 10.1 | 10.4 |
| Amylase, U/L | 369 | 348 | 349 |
| Hemoglobin, g/dL | 14.7 | 17.4 | 15.8 |
| Hematocrit, % | 43.1 | 53.1 | 50.3 |
| WBC, 10³/microl | 11.6 | 13.5 | 8.4 |
| RBC, 10⁶/microl | 6.59 | 7.97 | 7.57 |
| MCV | 65 | 67 | 66 |
| MCH | 22.3 | 21.8 | 20.9 |
| MCHC | 34.1 | 32.8 | 31.4 |
| Platelet count, 10³/microl | 394 | 406 (H) | 385 |
| Neutrophils, absolute, (%) | 8236 (71) | 10665 (79) | 6132 (73) |
| Bands | 0 | 0 | 0 |
| Lymphocytes, absolute, (%) | 2088 (18) | 2025 (15) | 1428 (17) |
| Monocytes, absolute, (%) | 464 (4) | 405 (3) | 336 (4) |
| Eosinophils, absolute, (%) | 812 (7) | 405 (3) | 504 (6) |
| Basophils, absolute, (%) | 0 | 0 | 0 |

The above-described examples demonstrate the efficacy of inorganic mercury (II) in treating the residual cancer disease after tumor removal including metastasized cancer. The next two examples report that dogs with advanced cancer and bulk tumor respond positively to mercury-based therapy, as evidenced by improvement in their general health and reduction in the level of tumor markers.

### Example 3

An 8 year old, 108 lbs female Rottweiler, was diagnosed with non-metastatic osteosarcoma on distal right radius.

### Clinical Evaluation Prior to Treatment

Earlier cisplatin chemotherapy was attempted, but was stopped due to unacceptable side effects one month before the inorganic mercury treatment. Prior to treatment, the dog had high alkaline phosphatase (ALP) level that had been rising as disease progressed (compare Day (−57) and Day 1 in Table 2). ALP is a known progression marker for osteosarcoma (Kirpensteijn et al., 2002, Vet Pathol 39:240-246 and Gaetano Bacci et al., 2002, Oncology Reports 9: 171-175). The dog completed the first 30-day treatment course followed by a 30-day non-treatment period and started the second treatment course for at least up to day 65. The formulation contained 1 mM mercury acetate in 20 mM sodium acetate buffer, pH 4.5, with 100 mM sucrose and 150 mM sodium chloride additives. It was introduced orally to the dog three times a day at 0.5 micromole Hg²⁺/kg/day. During the first 30 days the dog was administered formulation 1 hour before or after taking food, as it was specified in the treatment protocol, and, as seen in Table 2, during this time period the serum ALP level decreased from 794 (Day 1) to 539 (Day 32). This drop in ALP level (˜250 Units/month) was significant considering that, prior to starting the mercury (II) treatment, it had been raising at ˜50 U/month rate. As observed by the attending veterinarian, the dog's appetite was increased and the dog gained 5 lbs during that period. Regrettably, for the 2nd treatment course, the owner decided to administer the formulation with food, in violation of the protocol, as the dog did not like the taste. During this period the condition of the dog worsened and was accompanied by an increase in ALP level (compare Day 32 and Day 65 in Table 3). The dog was euthanized on Day 91.

TABLE 3
Blood data for 8 years old female Rottweiler before and during inorganic
mercury (II) treatment.

| Blood Parameter | Day (−57) | Day 1 | Day 32 | Day 65 |
|---|---|---|---|---|
| Glucose, mg/dL | 98 | 77 | 102 | 87 |
| Urea Nitrogen, mg/dL | 18 | 11 | 16 | 15 |
| Creatinine, mg/dL | 1.1 | 1.2 | 1.3 | 1.2 |
| Total Protein, g/dL | 7.2 | 7.1 | 6.8 | 7.5 (H) |
| Albumin, g/dL | 3.9 | 3.7 | 3.5 | 3.8 |
| Total Billirubin, mg/dL | 0.1 | 0.1 | 0.2 | 0.1 |
| Alkaline Phosphatase | 696 (H) | 794 (H) | 539 (H) | 606 (H) |
| (ALP), U/L | | | | |
| ALT (SGPT), U/L | 50 | 61 | 61 | 62 |
| AST (SGOT), U/L | 29 | 28 | 27 | 30 |
| Cholesterol, mg/dL | 219 | 240 | 251 | 244 |
| Calcium, mg/dL | 10.5 | 10.6 | 10.5 | 10.9 |
| Phosphorus, mg/dL | 5.8 | 5.4 | 5.5 | 5.1 |
| Sodium, mE/L | 148 | 152 | 146 | 150 |
| Potassium, mE/L | 5.2 | 5.2 | 5.2 | 4.6 |
| Chloride, mE/L | 115 | 116 | 118 | 113 |
| Albumin/Globulin Ratio | 1.2 | 1.1 | 1.1 | 1.0 |
| BUN/Creatinine Ratio | 16 | 9 | 12 | 13 |
| Globulin, g/dL | 3.3 | 3.4 | 3.3 | 3.8 (H) |
| CPK, U/L | 108 | 175 | 198 | 171 |
| Amylase, U/L | 961 | 862 | 864 | 1003 |
| Hemoglobin, g/dL | 16.0 | 13.7 | 13.9 | 16.1 |
| Hematocrit, % | 46.9 | 41.3 | 39.1 | 42.3 |
| WBC, 10³/microl | 14.2 | 11.0 | 9.9 | 10.1 |
| RBC, 10⁶/microl | 7.25 | 6.16 | 5.64 | 6.49 |
| MCV | 65 | 67 | 69 | 65 |
| MCH | 22.1 | 22.2 | 24.6 | 24.8 |
| MCHC | 34.1 | 33.2 | 35.5 | 38.1 (H) |
| Platelet count, 10³/microl | 361 | 475 (H) | 213 | 368 |
| Neutrophils, | 9656 (68) | 6710 (61) | 5445 (55) | 5555 (55) |
| absolute, (%) | | | | |
| Bands | 0 | 0 | 0 | 0 |
| Lymphocytes, | 3124 (22) | 2860 (26) | 3465 (35) | 3333 (33) |
| absolute, (%) | | | | |
| Monocytes, absolute, (%) | 710 (5) | 660 (6) | 495 (5) | 404 (4) |
| Eosinophils, | 710 (5) | 770 (7) | 495 (5) | 808 (8) |
| absolute, (%) | | | | |
| Basophils, absolute, (%) | 0 | 0 | | 0 |

This outcome, however regrettable, points out to the importance of administering the medication in its present formulation without food additives.

### Example 4

A 10 years old female English Setter was diagnosed with a non-operable neck tumor of unknown origin and metastasis in the lungs.

### Clinical Evaluation Prior to Treatment

Pathology Report

“Source: Subcutaneous mass at deep aspect of cervical (neck) region, dorsal to trachea. Microscopic description: Both slides are examined and they are similar showing a specimen of moderate to high cellularity that contains large numbers of red cells with moderate numbers of leukocytes seen that are not higher than that expected from the peripheral blood elements alone with low numbers of activated macrophages and rare nondegenerate neutrophils. Moderate numbers of tissue cells seen and these consist of clumps of relatively uniform round (epithelial) cells with mild to minimal dysplastic or anaplastic changes and relatively abundant, lightly basophilic cytoplasm. No organism or any evidence of an eosinophilic response is noted.

Microscopic interpretation: Consistent with hemorrhage and well differentiated epithelial neoplasm.

Comment: The level of anaplasia/atypia seen is modest, but sufficient to strongly suggest a carcinoma—the tissue of origin cannot be determined based on the findings here. The site of the lesion is not characteristic of a malignant thyroid neoplasm. Urge surgical exploratory of the site with (excisional) biopsy, if appropriate, to verify”.

The dog completed 130-day inorganic mercury (II) treatment that consisted of 58 days of the first treatment course followed by 20 days of an interval period, and the 52-day second treatment course. The formulation contained 1 mM mercury acetate in 20 mM sodium acetate buffer, pH 4.5, with 100 mM sucrose and 150 mM sodium chloride additives. It was introduced orally to the dog three times a day at 0.5 micromole Hg²⁺/kg/day. At the start of the treatment, the dog was in poor health condition: was easily tired, had difficulty to swallow, heavy breathing due to lung metastasis. The tumor was easily palpated at the neck. During the first treatment course the dog showed a steady improvement in its general condition. These changes were correlated with reduction in ALP levels (Days 5, 22, 40, 65).

Owner's Notes

Day 38: “it seems that breathing slightly improved, and P. can sleep through the night without making too much noise.”

Day 50: “it seems that dog is feeling better and finally has a cold and wet nose—definite improvement compare to the beginning of the first cycle (treatment course, Y.S.)”

Day 57: “it seems that the dog is breathing easier . . . P. was able to sustain 10 minutes walk better than 2 weeks ago”.

About 2 weeks after starting an interval period (˜Day 72), the dog's condition was significantly worsened prompting initiation of a second treatment course earlier than planned. During the second treatment course the progression of the disease was slowed down, but not to the degree observed during the first treatment course. The treatment was stopped at Day 128, and the dog was euthanized 2-3 weeks later.

TABLE 4
Blood data for 10 years old female English Setter before and during inorganic mercury (II)
treatment.

| | Day | | Day | Day | Day | Day | Day |
|---|---|---|---|---|---|---|---|
| Blood Parameter | (−150) | Day 5 | 22 | 40 | 65 | 103 | 128 |
| Glucose, mg/dL | 99 | 116 | 102 | 99 | 94 | 107 | 116 |
| Creatinine, mg/dL | 1.0 | 0.9 | 0.8 | 0.9 | 1.0 | 0.8 | 0.8 |
| Total Protein, g/dL | 6.8 | 6.2 | 6.1 | 6.4 | 5.9 | 5.6 | 5.6 |
| Albumin, g/dL | 3.8 | 3.3 | 3.3 | 3.4 | 3.5 | 3.2 | 3.0 |
| Direct Billirubin, | 0 | 0 | 0 | 0.1 | 0.1 | 0.1 | 0.1 |
| mg/dL | | | | | | | |
| Total Billirubin, | 0.2 | 0.2 | 0.1 | 0.1 | 0.1 | 0.1 | 0.1 |
| mg/dL | | | | | | | |
| Indirect Billirubin, | 0.2 | 0.2 | 0.1 | 0 | 0 | 0 | 0 |
| mg/dL | | | | | | | |
| Alkaline Phosphatase | 89 | 204 | 142 | 111 | 78 | 58 | 45 |
| (ALP), U/L | | | | | | | |
| ALT (SGPT), U/L | 82 | 84 | 84 | 87 | 111 | 95 | 89 |
| AST (SGOT), U/L | 24 | 22 | 13 | 20 | 28 | 25 | 23 |
| Cholesterol, mg/dL | 271 | 269 | 230 | 222 | 169 | 146 | 133 |
| Calcium, mg/dL | 11.1 | 11.7 | 10.8 | 11.0 | 10.5 | 9.6 | 9.9 |
| Phosphorus, mg/dL | 3.9 | 5.2 | 3.6 | 4.6 | 4.4 | 3.7 | 3.1 |
| Sodium, mE/L | 153 | 152 | 150 | 151 | 150 | 148 | 151 |
| Potassium, mE/L | 5.7 | 4.8 | 5.7 | 5.7 | 5.2 | 5.2 | 4.8 |
| Chloride, mE/L | 113 | 113 | 113 | 110 | 109 | 107 | 116 |
| Na/K ratio | 27 | 32 | 26 | 26 | 29 | 28 | 31 |
| Anion Gap | 24 | 26 | 24 | 28 | 27 | 27 | 22 |
| T4, microg/dL | 1.7 | 1.4 | 1.8 | — | 1.6 | 1.4 | 1.1 |
| tCO2, mEq/L | 22 | 18 | 19 | 19 | 19 | 19 | 19 |
| Albumin/Globulin | 1.3 | 1.1 | 1.2 | 1.1 | 1.5 | 1.3 | 1.2 |
| Ratio | | | | | | | |
| BUN, mg/dL | 22 | 39 | 17 | 22 | 30 | 13 | 24 |
| BUN/Creatinine Ratio | 22 | 43.3 | 21.3 | 24.4 | 30 | 16.3 | 30 |
| Globulin, g/dL | 3.0 | 2.9 | 2.8 | 3.0 | 2.4 | 2.4 | 2.6 |
| CPK, U/L | 69 | 84 | 96 | 124 | 120 | 103 | 53 |
| GGT, U/L | 1 | 2 | 3 | 2 | 7 | 6 | 13 |
| Amylase, U/L | 553 | 771 | 738 | — | 431 | 745 | 633 |
| Lipase, U/L | 570 | 799 | 718 | — | 449 | 630 | 415 |
| Hemoglobin, g/dL | 16.1 | 14.5 | 15.2 | 14.8 | 14.3 | 13.4 | 12.3 |
| Hematocrit, % | 47.5 | 41.8 | 44.7 | 46.1 | 44.6 | 40.7 | 38.1 |
| WBC, 10³/microl | 16.8 | 14.4 | 16.6 | 16 | 21.1 | 16.5 | 16.9 |
| RBC, 10⁶/microl | 6.71 | 5.9 | 6.26 | 6.26 | 6.09 | 5.72 | 5.44 |
| MCV | 71 | 71 | 71 | 74 | 73 | 71 | 70 |
| MCH | 23.9 | 24.5 | 24.3 | 23.7 | 23.5 | 23.4 | 22.6 |
| MCHC | 33.8 | 34.7 | 34.1 | 32.2 | 32.1 | 32.9 | 32.2 |
| Platelet count, | 448 | 534 | 483 | 511 | 404 | 409 | 508 |
| 10³/microl | | | | | | | |
| Neutrophils, absolute, | 5544 (33) | 5904 (41) | 5644 (34) | 4640 (29) | 8018 (38) | 3300 (20) | 7943 (47) |
| (%) | | | | | | | |
| Lymphocytes, | 10080 (60) | 6912 (48) | 10624 (64) | 10240 (64) | 12871 (61) | 11715 (71) | 7774 (46) |
| absolute, | | | | | | | |
| (%) | | | | | | | |
| Monocytes, absolute, | 504 (3) | 864 (6) | | 960 (6) | | 1155 (7) | 845 (5) |
| (%) | | | | | | | |
| Eosinophils, absolute, | 672 (4) | 576 (4) | 332 (2) | 160 (1) | 211 (1) | 165 (1) | 330 (2) |
| (%) | | | | | | | |

This example demonstrates the importance of continuing treatment until stable clinical improvement or remission is reached, if possible.

1. A method for inhibiting proliferation of cancer cells in a mammal in need thereof comprising a systemic delivery at least once to said mammal a composition comprising inorganic mercury (II) in ionized or ionizable form and a carrier or excipient in an amount effective to inhibit proliferation of said cancer cells.

2. The method according to claim 1, wherein said cancer cells are solid tumor cancer cells.

3. The method according to claim 1, wherein said solid tumor cancer cells are selected from the group consisting of, but not limited to, lung cancer, breast cancer, ovarian cancer, prostate cancer, bowel cancer, brain cancer, testicular cancer, colon cancer, liver cancer, kidney cancer, pancreas cancer, skin cancer, neck cancer, uterus cancer, bone cancer.

4. The method according to claim 1, wherein said cancer cells are dispersed cancer cells.

5. The method according to claim 1, wherein said dispersed cancer cells are selected from the group consisting of lymphoma and leukemia.

6. The method according to claim 1 wherein the mammal is a human.

7. The method according to claim 1, wherein the mammal is a dog or cat.

8. The method according to claim 1, wherein said composition is administered orally.

9. The method according to claim 1, wherein said composition is administered parenterally.

10. The method according to claim 8, wherein said composition is administered via a pulmonary route.

11. A method for inhibiting proliferation of cancer cells in a mammal in need thereof comprising a local, topical or transdermal delivery at least twice to said mammal a composition comprising inorganic mercury (II) in ionized or ionizable form and a carrier or excipient in an amount effective to inhibit proliferation of said cancer cells.

12. The method according to claim 11, which comprises an initial administration of said composition and at least one subsequent administration of said composition 2-30 days after initial administration.

13. The method according to claim 11, which comprises an initial administration of said composition and at least two subsequent administrations of said composition 2-30 days after initial administration.

14. A Method for treating cancer in a mammal comprising systemic administration at least once, to said mammal in need thereof, a dose corresponding to about 0.001-100 micromole Hg²⁺/kg/day for humans to said mammal.

15. The method according to claim 14, wherein said inorganic mercury compound is in the form of any mercury (II) compound in an ionized or ionizable form.

16. The method according to claim 14, wherein said cancer is a primary cancer.

17. The method according to claim 14, wherein said cancer is a metastatic cancer.

18. A method for inhibiting metastases of a tumor in a mammal in need thereof comprising administering to said mammal in need thereof a non-wine, non-whey, non-pork fat containing composition comprising an amount of at least one inorganic mercury (II) compound in ionized or ionizable form effective to inhibit said metastases.

19. A method for inhibiting metastases of a tumor in a mammal in need thereof comprising administering to said mammal in need thereof, a dose corresponding to about 0.001-100 micromole Hg²⁺/kg/day inorganic mercury (II) for humans.

20. A non-wine, non-whey, non-pork fat containing composition comprising an inorganic mercury (II) containing compound present in an amount of about 0.1 nanomole to about 50 millimoles Hg²⁺per single dosage unit and a carrier or excipient.

21. The composition according to claim 20, wherein said composition is an aqueous composition.

22. The composition according to claim 20, wherein said composition is a pharmaceutical composition.

23. An aqueous buffered formulation in injectable or oral form comprising at least one inorganic mercury (II) containing compound.

24. A method for producing the composition of claim 23, comprising dissolving an inorganic mercury (II) containing compound in said buffer.

25. Use of non-wine, non-whey, non-pork fat ionized or ionizable containing composition comprising an amount of inorganic mercury (II) to treat cancer in a mammal.

26. Use of about 0.001-100 micromole Hg²⁺/kg/day inorganic mercury (II) for at least once to treat cancer in a patient.

27. A pharmaceutical composition comprising a non-wine, non-whey, non-pork fat containing composition comprising an inorganic mercury (II) containing compound present in an amount of about 0.1 nanomole to about 50 millimoles Hg²⁺per single dosage unit and a carrier or excipient for use in treating cancer or inhibiting metastases in a subject.
